(19) United States
(12) Patent Application Publication
(10) Pub. No.: US 2009/0153534 A1
(43) Pub. Date: Jun. 18, 2009

(54) SEMICONDUCTOR INTEGRATED CIRCUIT DEVICE AND DISPLAY APPARATUS

(75) Inventors: Yasuyuki YOKOTA, Yokohama (JP); Yasuhiro Ogata, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 12/336,442

(22) Filed: Dec. 16, 2008

(30) Foreign Application Priority Data
Dec. 18, 2007 (JP) 2007-325727

(51) Int. Cl. G09G 5/00; G09G 3/36

(52) U.S. Cl. 345/204; 345/98

(57) ABSTRACT

A semiconductor integrated circuit device and a display apparatus each having enhanced electromagnetic immunity realized using a simple configuration are provided. The semiconductor integrated circuit device has a group of registers, an interface circuit, and a timing generation circuit. The signal processing circuit has a signal processing function which is set by setting information stored in the group of registers. The timing generation circuit generates a periodic timing signal and supplies it to the interface circuit. The interface circuit periodically, based on the timing signal, writes setting information inputted from an external terminal to the group of registers.

### CROSS-REFERENCE TO RELATED APPLICATIONS

The disclosure of Japanese Patent Application No. 2007-325727 filed on Dec. 18, 2007 including the specification, drawings and abstract is incorporated herein by reference in its entirety.

### BACKGROUND OF THE INVENTION

The present invention relates to a semiconductor integrated circuit device and a display apparatus. More particularly, it relates to technology effectively applicable to cope with insufficient electro-magnetic immunity of, for example, a semiconductor integrated circuit device for driving a liquid crystal display and a liquid crystal display apparatus.

A liquid crystal apparatus in which unwanted radiation noise, i.e. electromagnetic interference (EMI), is reduced is disclosed in Japanese patent laid-open No. 2000-028998. According to the disclosure, the waveform of a drive signal applied to a liquid crystal panel can be set and changed using a waveform data signal transmitted via a data line. The waveform data signal is transmitted only during a constant period of time for changing the drive signal, so that unwanted radiation noise can be reduced. In this way, EMI against other electronic apparatuses can be reduced.

There is an international standard (CISPR) specifying electromagnetic immunity requirements, in terms of electromagnetic susceptibility (EMS), for electronic products. An electronic product complying with the standard can function normally even when it is subjected to electromagnetic noise of a level specified by the standard leaking from other electronic products. A corresponding Japanese standard (VCCI) is based on the CISPR standard.

### SUMMARY OF THE INVENTION

The following measures (1) to (6) are generally taken to meet electromagnetic interference immunity requirements, for example, as specified by the above standards.
(1) Inserting regulators in common wirings such as wirings for power supply and grounding so as to reduce the effects of external noise infiltrating via such wirings, and using bypass capacitors having favorable frequency characteristics in appropriate locations, for example, locations near a circuit board entrance.
(2) Using noise reducing parts, for example, ferrite beads or inserting noise filters and varistors to reduce noise entering input/output signals and data.
(3) Using shielded wires for long signal lines, or making differential signal transmission using twisted-pair wires.
(4) Reducing signal impedance to reduce noise directly induced in wiring.
(5) Using shield plates, or putting a circuit board in a shield case.
(6) Arranging components and wirings in such a way as to reduce electromagnetic interference.
   Taking these measures for an electronic product will allow the electronic product to meet the above standards.

There is, however, a tendency among end-product manufacturers and module manufacturers to apply, when inspecting liquid crystal driver LSI devices for acceptance, much severer criteria as to electromagnetic interference immunity than the above standards. To pass such severe inspection as to electromagnetic interference immunity, manufacturers of liquid crystal driver LSI devices will have to spend a lot of time determining how to appropriately combine the above measures (1) to (6) for their products and/or developing a new measure to enhance the electromagnetic interference immunity of their products. The inventors of the present invention has come to devise the invention as a result of giving attention to the fact that electromagnetic immunity requirements of end-product manufacturers and module manufacturers only require that liquid crystal driver LSIs be capable of resuming normal display operation when electromagnetic noise is removed without requiring the relevant hardware to be reset or the relevant system controller to be initialized.

It is an object of the present invention to provide a semiconductor integrated circuit device and a display apparatus each having enhanced electromagnetic immunity realized using a simple configuration. The above and other objects of the invention and its novel features will become obvious from the description of this specification and the attached drawings.

According to an embodiment disclosed in this specification, a semiconductor integrated circuit device has a signal processing circuit, registers, an interface circuit, and a timing generation circuit. The signal processing circuit has a signal processing function which is set by setting information stored in the registers. The timing generation circuit generates a periodic timing signal and supplies it to the interface circuit. The interface circuit periodically, based on the timing signal, writes setting information inputted from an external terminal to the registers.

According to another embodiment disclosed in this specification, a display apparatus has a microprocessor, a first non-volatile memory, a display signal output circuit, a display timing output circuit, and a display panel. The display signal output circuit includes a signal processing circuit, registers, an interface circuit, and a timing generation circuit. The signal processing circuit forms a display output signal corresponding to setting information stored in the registers and display data inputted from the microprocessor. The timing generation circuit generates a periodic timing signal and supplies it to the interface circuit. The interface circuit writes, corresponding to the timing signal, setting information inputted from the first non-volatile memory to the registers.

The setting information stored in the registers is periodically updated, so that, even if the setting information is lost due to electromagnetic interference, normal signal processing operation can be resumed automatically when electromagnetic noise is removed.

### BRIEF DESCRIPTION OF THE DRAWINGS

FIG. 1 is a block diagram showing an LCD driver LSI according to an embodiment of the present invention.

FIG. 2 is a schematic block diagram showing an LCD driver LSI according to another embodiment of the invention.

FIG. 3 is a schematic block diagram showing an LCD driver LSI according to still another embodiment of the invention.

FIG. 4 is an overall block diagram showing a liquid crystal display apparatus according to an embodiment of the invention, the apparatus incorporating an LCD driver LSI according to the invention.

### DETAILED DESCRIPTION OF THE PREFERRED EMBODIMENTS

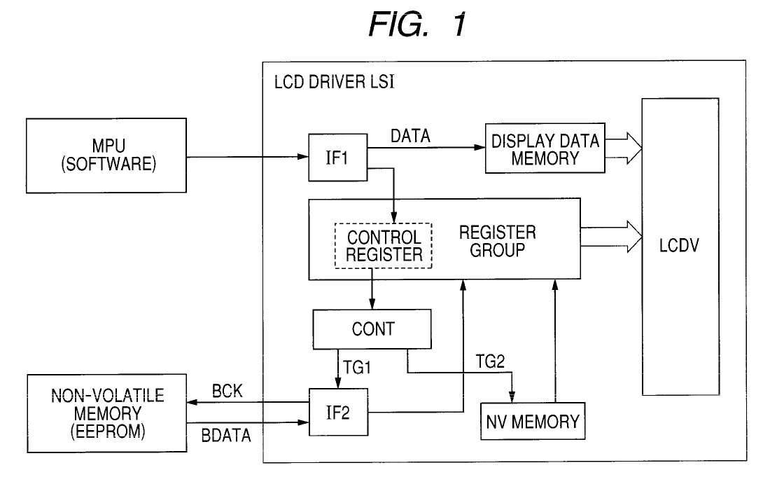

FIG. 1 is a block diagram showing a liquid crystal display (LCD) driver LSI according to an embodiment of the present invention along with other devices related with the LCD driver LSI. The LCD driver LSI is a semiconductor integrated circuit formed on a semiconductor substrate, for example, by a known CMOS semiconductor production method. The LCD driver LSI can be used to supply a display signal to various types of LCD panels of cellular phones. LCD panels vary, depending on the number of pixels they have, in the numbers of scanning line electrodes to which thin film transistor (TFT) gate electrodes are coupled and signal line electrodes for supplying, via the TFTs, display signals to pixel electrodes. Display signals to be supplied to LCD panels require gradation settings to be made involving, for example, tap adjustment and voltage division adjustment according to input display data. Display signals also require various corrections including, for example, gamma correction to be made based on the performance of individual LCD panels.

Making such adjustments and corrections fixedly in the LCD driver LSI makes the LCD driver LSI good only for a particular display panel. Such an approach reduces the mass-productivity of the LCD driver LSI and makes the LCD driver LSI very expensive. Not to cause such a situation, the LCD driver LSI is provided with a group of registers (a group of control registers). The resisters store various pieces of setting information as described above thereby making the LCD driver LSI capable of performing display operation for various types of display panels.

The setting information for display operation and display data is inputted via an interface circuit IF1 which receives signals from a host system, for example, a data processing unit or a microprocessor MPU. The LCD driver LSI of the present embodiment allows a separate non-volatile memory to be coupled to it, so that it need not take time to have all setting information required for display operation inputted from a host system like the microprocessor MPU every time it is powered on. The non-volatile memory is an electrically writable/rewritable one, for example, a flash memory EEPROM. The non-volatile memory stores various setting information to be stored in the registers.

When an apparatus, for example, a cell-phone incorporating the LCD driver LSI is initialized, required setting information is inputted from a host system like the microprocessor MPU to the registers. When this is done, the same setting information is also written to the non-volatile memory. Alternatively, a non-volatile memory into which the setting information has been written using a special writing device may be coupled to the LCD driver LSI. In FIG. 1, CONT represents a control circuit to control an interface circuit IF2 corresponding to the non-volatile memory.

When the cell-phone having been once initialized is powered on, the setting information is written into the registers not from a host system like the microprocessor MPU but directly from the non-volatile memory using the control circuit CONT and the interface circuit IF2. The microprocessor MPU is therefore released from the operation for inputting, immediately after the cell-phone is powered on, the setting formation for display operation to the registers. This allows the microprocessor MPU to perform other signal processing operations, so that the time required before the cell-phone becomes ready for use after being powered on can be shortened.

In the present embodiment, the LCD driver LSI includes, though not limited to it, a small-capacity non-volatile memory (NV memory). The NV memory can store some of the setting information to be stored in the registers. For example, information which can be factory set fixedly in the LCD driver LSI may be stored in the NV memory. By incorporating the NV memory in the LCD driver LSI, the volume of information to be inputted from the microprocessor MPU to the registers can be reduced. This also reduces setting errors. The information stored in the NV memory is not limited to part of the information to be stored in the registers. The NV memory may store the whole information to be stored in the registers.

Referring to FIG. 1, the display data memory stores display data, represented by DATA, inputted via the microprocessor MPU. The display output circuit LCDV forms, based on the display data stored in the display data memory and the setting information stored in the registers, a display output signal to be transmitted to the signal line of the LCD panel.

The present embodiment incorporates a function, as described in the following, for improving the electromagnetic immunity of an LCD driver LSI and a display apparatus. The present invention is not for eliminating display problems caused by electromagnetic interference but for enabling normal display operation to be automatically resumed when electromagnetic noise is removed. The function is realized as follows. A predetermined control command issued by the microprocessor MPU sets a control value in one (a first control register) of the control registers via the interface circuit IF1. The control circuit CONT, responding to the control value set in the first control register, outputs trigger signals TG1 and TG2 to the interface circuit IF2 and the NV memory, respectively, for example, with a period of about one second. Though not limited to be so, the command is issued by software incorporated in the microprocessor MPU; the command is detected by a command decoder included in the interface circuit IF1; and the command decoder then sets the value specified by the command in the first control register.

When the control command is received, the control circuit CONT generates, similarly to when the cell-phone was powered on, a trigger signal TG1 and thereby activates the interface circuit IF2 causing a read clock signal BCK to be sent to the non-volatile memory via the interface circuit IF2. The control circuit CONT then receives the read data BDATA in response to the read clock signal BCK and writes the BDATA to the registers. Similarly, the NV memory responding to the trigger signal TG2 writes, similarly to when the cell-phone was powered on, the information stored in it to the registers.

The control command may be, for example, an automatic refresh command (ATRFSH) among the control commands used by the LCD driver LSI. The automatic refresh command (ATRFSH) is assigned a predetermined command address. When the automatic refresh command (ATRFSH) is issued from the microprocessor MPU to the LCD driver LSI, a control bit (for example, bit 1) of a corresponding first control register among the registers included in the LCD driver LSI, i.e. the first control register allocated to the predetermined command address is set to a predetermined value, for example, “0” or “1.” When the control bit of the first control register is set to, for example, “0” by the automatic refresh command, the automatic refresh function is determined to be in an inactive state. When the control bit of the first control register is set to, for example, “1” by the automatic refresh command, the automatic refresh function is determined to be in an active state.

Once the control bit of the first control register is set to, for example, “1” by the automatic refresh command and the automatic refresh function is activated, settings in other registers than the first control register, i.e. settings in multiple second control registers among the registers included in the LCD driver LSI are periodically updated (refreshed) by the read data BDATA including setting data written in the non-volatile memory or NV memory, for example, with a period of about one second.

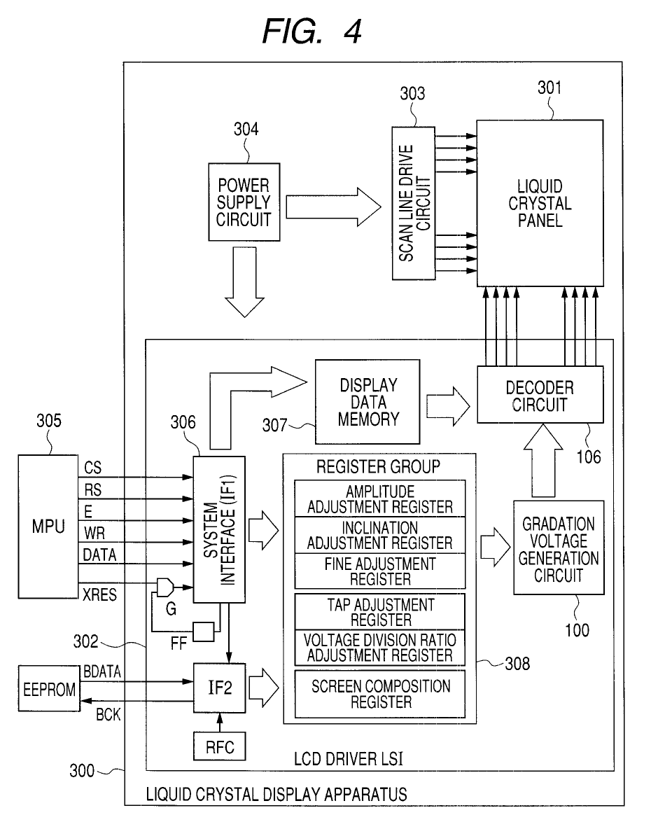

The second control registers store setting information which may include such parameters as frame frequency, number of drive lines, and drive voltage as well as information on amplitude adjustment, inclination adjustment, fine adjustment, tap adjustment, voltage division ratio, and screen composition, i.e. information on items being described later with reference to FIG. 4.

In the present embodiment, the setting information stored in the registers is updated regardless of whether or not electromagnetic interference is present. Therefore, no matter when the LCD driver LSI is disturbed by electromagnetic interference, the LCD driver LSI can resume normal display operation within a maximum of one second after the electromagnetic interference is removed. The control circuit CONT may be made to control all writing operations to the registers. Namely, writing to the NV memory may also be done by the control circuit CONT. To perform the periodical operation, a second pulse generated by a clock function (software) included in the microprocessor MPU may be used as a timing signal, or an external clock circuit, if any is provided, may be used. Thus, the electromagnetic immunity of the LCD driver LSI and the display apparatus can be securely improved using a simple device configuration.

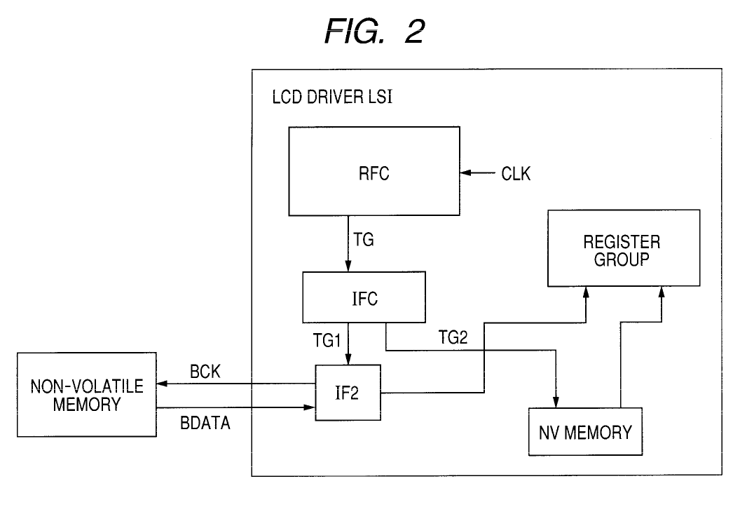

FIG. 2 is a schematic block diagram showing an LCD driver LSI according to another embodiment of the present invention. In FIG. 2, the display data memory and display output circuit LCDV required for display operation, the microprocessor MPU externally coupled to the LCD driver LSI, and the interface circuit IF1 corresponding to the microprocessor MPU that are shown in FIG. 1 are omitted. Namely, for this embodiment, FIG. 2 only illustrates, by way of example, parts related with electromagnetic interference.

In the present embodiment, the LCD driver LSI incorporates a refresh control circuit RFC. The refresh control circuit RFC controls refreshing of the setting information stored in the registers. Namely, the refresh control circuit RFC includes a timer circuit for counting internal operations of the LCD driver LSI, for example, for counting clock pulses CLK used to time scan line driving. Or, in cases where appropriate clock pulses CLK are not present, the refresh control circuit RFC may include an oscillator circuit to generate a trigger signal TG with a period of about one second similarly to the foregoing embodiment. The trigger signal TG is supplied to an interface control circuit IFC which is equivalent to the control circuit CONT shown in FIG. 1. The interface control circuit IFC generates trigger signals TG1 and TG2 similar to the TG1 and TG2 signals generated in the foregoing embodiment, allowing the setting information stored in an external non-volatile memory and an internal NV memory to be periodically written to the registers as done in the foregoing embodiment.

In cases where, as in the present embodiment, the setting information stored in the registers is periodically rewritten, it is possible to configure the registers with dynamic RAMs and use a short rewriting period corresponding to the information retention time of the dynamic memory cells. When the registers are configured with dynamic RAMs, the register configuration can be simplified and a very short rewriting period corresponding to the period with which the dynamic RAMs are refreshed can be used. This enables, no matter when the LCD driver LSI is disturbed by electromagnetic interference, the LCD driver LSI to resume normal display operation almost immediately after the electromagnetic interference is removed.

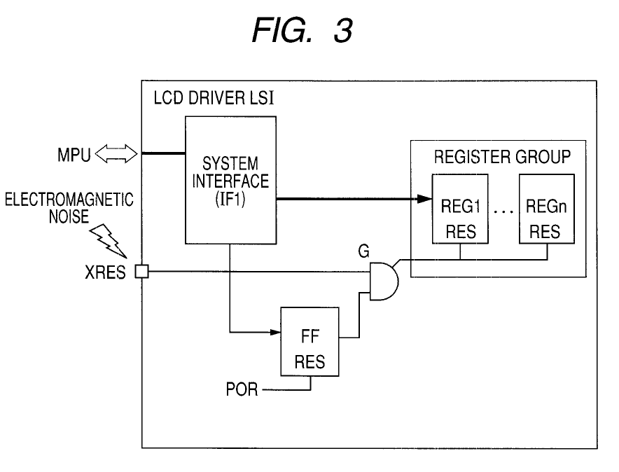

FIG. 3 is a schematic block diagram showing an LCD driver LSI according to still another embodiment of the present invention. In FIG. 3, the display data memory and display output circuit LCDV required for display operation and the microprocessor MPU and non-volatile memory externally coupled to the LCD driver LSI that are shown in FIG. 1 are omitted.

This embodiment has been devised as a result of giving attention to the fact that display problems attributable to electromagnetic interference result mainly when the electromagnetic interference causes the registers included in the LCD driver LSI to be reset. The registers include multiple registers REG1 to REGn. The registers each have a reset terminal RES to which a reset signal is transmitted from an external reset terminal XRES under control by the microprocessor MPU. When electromagnetic noise enters the external reset terminal XRES and causes a reset signal to be transmitted to the reset terminal RES of each of the registers REG1 to REGn, the information set in each of the registers REG1 to REGn is lost and display problems occur.

In the present embodiment, a gate circuit G for canceling the signal coming from the external reset terminal XRES is provided. The gate circuit G is controlled by a control signal formed by a flip-flop circuit FF which is set and reset by a system interface (including IF1) interfaced with the microprocessor MPU. For example, when, as described in the foregoing, the system is initialized or the system having been initialized is powered on, the flip-flop circuit FF is reset, for example, by a power-on reset signal POR. Subsequently, a command for deactivating the reset function is issued from the microprocessor MPU. The system interface circuit (IF1) reads the command and sets the flip-flop circuit FF to have the gate of the gate circuit G closed. Subsequently, even if electromagnetic noise enters the external reset terminal XRES and a reset signal which can cause the registers to be reset is generated, the reset signal is blocked by the gate circuit G not to be transmitted to the registers. This allows the setting information stored in the registers to be retained and thereby improves the electromagnetic immunity of the LCD driver LSI and the display apparatus.

FIG. 4 is an overall block diagram showing a liquid crystal display apparatus according to an embodiment of the invention. The apparatus incorporates an LCD driver LSI according to the invention. In the embodiment, a liquid crystal display apparatus 300 includes a liquid crystal panel 301, an LCD driver LSI 302 which is a signal line drive circuit having a gradation voltage generation part for outputting a gradation voltage corresponding to display data to a signal line of the liquid crystal display panel 301, a scan line drive circuit 303 for applying scan signals to the scan lines of the liquid crystal panel 301, and a power supply circuit 304 for supplying the signal line drive circuit 302 and the scan line drive circuit 303 with operating power. The voltages the power supply circuit 304 supplies to the LCD driver LSI 302 includes a gradation reference voltage. A microprocessor unit (MPU) 305 which performs various processes required to display an image on the liquid crystal display panel 301 is coupled to the liquid crystal display apparatus 300. The non-volatile memory EEPROM storing the setting information to be stored in the registers is also coupled to the liquid crystal display apparatus 300.

The LCD driver LSI 302 includes a system interface 306 for exchanging display data and control data with the MPU 305, a display data memory 307 for storing the display data outputted from the system interface 306, control registers 308 including a tap adjustment register 101, a voltage division ratio adjustment register 102, an amplitude adjustment register 103, an inclination adjustment register 104, a fine adjustment register 105 and a screen composition register, a gradation voltage generation circuit 100, and a decoder circuit 106.

When display data and a command are received from the MPU 305, the system interface 306 outputs the display data to the control registers 308, for example, based on the bus interface for the Motorola 68 series 16-bit microprocessor. The output operation is performed using such signals as a CS (Chip Select) signal to indicate a chip selection, an RS (Register Select) signal to determine which to select, the addresses of or the data stored in the control registers 308, an E (Enable) signal to direct processing activation, a WR (Write Read) signal to select data writing or reading, a DATA signal including addresses of control registers 308, setting data, or display data, and a reset signal XRES.

The command includes information used to determine internal operations of the LCD driver LSI 302, scan line drive circuit 303, and power supply circuit 304. The information includes such parameters as frame frequency, number of drive lines, and drive voltage as well as information on amplitude adjustment, inclination adjustment, fine adjustment, tap adjustment, voltage division ratio, and screen composition. The control registers 308 store the data provided by the command and outputs the data to the corresponding drive circuits.

The setting values stored in the control registers 308 can be individually changed from outside with ease, and various settings can be corrected or adjusted over wider ranges. This makes it possible to realize accurate color reproducibility for diversified liquid crystal display panels. Even though the present embodiment has been described without, for the sake of descriptive simplicity, giving attention to the concept of polarity-reversed driving to be performed in driving a liquid crystal display panel, the embodiment can also be applied with ease to such display control methods as common inversion, column inversion, and dot inversion. Even though, in the present embodiment, the display data is of six bits each, the number of bits need not be six.

The liquid crystal display apparatus according to the present embodiment is provided with a circuit for coping with electromagnetic interference shown in FIGS. 2 and 3. Namely as shown in FIG. 3, the reset signal XRES is inputted via the gate circuit G. The gate circuit G is controlled by the flip-flop circuit FF. As shown in FIG. 2, the interface circuit IF2 is activated by a trigger signal from the refresh control circuit RFC, and periodically rewrites the setting information stored in the non-volatile memory EEPROM to the registers. The NV memory shown in FIG. 2 is not shown in FIG. 4. The system interface circuit (IF1) shown in FIG. 4 may include the NV memory. The embodiment shown in FIG. 1 can, of course, be applied to the present embodiment.

In the present embodiment, the LCD driver LSI has two types of circuits for coping with electromagnetic interference, and the function shown in FIG. 3 is selectively enabled using the command as described above. The operation of the circuit for coping with electromagnetic interference shown in FIG. 2 may also be enabled/disabled using a command. For example, in cases where display operation is not performed, the refresh control circuit like the one shown in FIG. 2 may be deactivated to save power.

The present invention has been concretely described based on embodiments, but the invention is not limited to the embodiments and it can be modified in various ways without departing from its scope. The semiconductor integrated circuit device and display apparatus may not necessarily be an LCD driver LSI for an LCD panel and an LCD apparatus like those described above. They may be, for example, a driver LSI for an organic EL panel and an organic EL display apparatus. Furthermore, the semiconductor integrated circuit device need not necessarily be a display driver circuit as described above. It may be a signal processing circuit, for example, a processor to perform signal processing operations whose contents are set and changed based on information stored in registers.

The present invention is widely applicable to various types of semiconductor integrate circuit devices for performing signal processing operations whose contents can be set and changed based on setting information stored in registers and also to semiconductor integrated circuit devices and display apparatuses in which display output signals are formed based on setting information stored in registers.

1. A semiconductor integrated circuit device comprising:
a signal processing circuit;
a group of registers;
a first interface circuit corresponding to a first external terminal; and
a second interface circuit corresponding to a second external terminal,
wherein the signal processing circuit has a signal processing function which is set by setting information stored in the group of registers,
wherein the first interface circuit writes setting information received from a host system via the first external terminal to the group of registers and provides a periodic timing signal, and
wherein the second interface circuit writes setting information received, corresponding to the periodic timing signal, from a first non-volatile memory via the second external terminal to the group of registers.

2. A semiconductor integrated circuit device comprising:
a signal processing circuit;
a group of registers;
a first interface circuit corresponding to a first external terminal;
a second interface circuit corresponding to a second external terminal; and
a timing generation circuit,
wherein the signal processing circuit has a signal processing function which is set by setting information stored in the group of registers,
wherein the timing generation circuit generates a periodic timing signal,
wherein the first interface circuit writes setting information received from a host system via the first external terminal to the group of registers, and
wherein the second interface circuit writes setting information received, corresponding to the periodic timing signal, from a first non-volatile memory via the second external terminal to the group of registers.

3. The semiconductor integrated circuit device according to claim 1, further comprising, internally, a second non-volatile memory, the second non-volatile memory storing part of the setting information,
wherein the part of the setting information is, when operation to write setting information to the group of registers is carried out, written to the group of registers along with other part of the setting information.

4. The semiconductor integrated circuit device according to claim 3, further comprising a control unit for selectively deactivating a function for resetting the group of registers from an external terminal.

5. The semiconductor integrated circuit device according to claim 3,
wherein the signal processing circuit includes:
a display data memory; and
a display output circuit which outputs display data stored in the display data memory as a gradation display signal, and
wherein the group of registers includes:
an adjustment register storing a setting signal for use in forming the gradation display signal; and
a screen composition register storing setting information corresponding to a display panel to which the gradation display signal is outputted.

6. A semiconductor integrated circuit device comprising:
a signal processing circuit;
a group of registers; and an interface circuit,
wherein the signal processing circuit has a signal processing function which is set by setting information stored in the group of registers, and
wherein the interface circuit has a control unit for selectively deactivating a function for resetting the group of registers from an external terminal.

7. A semiconductor integrated circuit device according to claim 6,
wherein the interface circuit includes:
a first interface circuit corresponding to a first external terminal; and
a second interface circuit corresponding to a second external terminal,
wherein the first interface circuit writes, when the device is being initialized, setting information received from a host system via the first external terminal to the group of registers, and
wherein the second interface circuit writes, when the device having been initialized is powered on, setting information received from a first non-volatile memory via the second external terminal to the group of registers.

8. The semiconductor integrated circuit device according to claim 7,
wherein the signal processing circuit includes:
a display data memory; and
a display output circuit which outputs display data stored in the display data memory as a gradation display signal, and
wherein the group of registers includes:
an adjustment register storing a setting signal for use in forming the gradation display signal; and
a screen composition register storing setting information corresponding to a display panel to which the gradation display signal is outputted.

9. A display apparatus comprising:
a microprocessor;
a first non-volatile memory;
a display signal output circuit;
a display timing output circuit; and
a display panel,
wherein the display signal output circuit includes:
a signal processing circuit;
a group of registers;
an interface circuit; and
a timing generation circuit,
wherein the signal processing circuit forms a display output signal corresponding to setting information stored in the group of registers and display data inputted from the microprocessor,
wherein the timing generation circuit generates a periodic timing signal and supplies it to the interface circuit, and
wherein the interface circuit writes, corresponding to the timing signal, setting information inputted from the first non-volatile memory to the group of registers.

10. The display apparatus according to claim 9,
wherein the interface circuit includes:
a first interface circuit corresponding to a first external terminal; and
a second interface circuit corresponding to a second external terminal,
wherein the first interface circuit writes setting information received from the microprocessor via the first external terminal to the group of registers, and
wherein the second interface circuit writes setting information received from the first non-volatile memory via the second external terminal to the group of registers.

11. The display apparatus according to claim 10,
wherein the signal processing circuit includes:
a display data memory; and
a display output circuit which outputs display data stored in the display data memory as a gradation display signal, and
wherein the group of registers includes:
an adjustment register storing a setting signal for use in forming the gradation display signal; and
a screen composition register storing setting information corresponding to a display panel to which the gradation display signal is outputted.

12. The display apparatus according to claim 11,
wherein the first interface circuit further includes a control unit which selectively deactivates, according to a command from the microprocessor, a function for resetting the group of registers from an external terminal.

13. A semiconductor integrated circuit device comprising:
a register group including a first register and a second register;
a signal processing circuit an operation of which is controlled by setting information stored in the second register; and
an updating unit which, after a command to set the first register to a predetermined value is received from outside the semiconductor integrated circuit device, periodically updates a setting value stored in the second register.

14. The semiconductor integrated circuit device according to claim 13, wherein the updating unit updates the setting value stored in the second register every second.

15. The semiconductor integrated circuit device according to claim 13, further comprising:
a first external terminal; and
a second external terminal to which a first non-volatile memory is to be coupled,
wherein, when the command is supplied to the first external terminal, a setting value supplied from the first non-volatile memory via the second external terminal is stored in the second register.

16. A semiconductor integrated circuit device comprising:
a register group including a first register and a second register;
a memory to store display data for display on a display panel;
a drive circuit which supplies a drive signal to the display panel based on data received from the memory; and
an updating unit which, after a command to set the first register to a predetermined value is received from outside the semiconductor integrated circuit device, periodically updates a setting value stored in the second register.

17. A display apparatus comprising:
a data processing device;
a first non-volatile memory;
a signal output circuit coupled to the display data processing device and the first non-volatile memory; and
a display panel coupled to the display signal output circuit,
wherein the display signal output circuit has:
a signal processing circuit;
a register group including a first register and a second register;
an interface circuit; and
a timing generation circuit,
wherein the signal processing circuit can, responding to a command from the data processing device, set setting information in the first register and form a display output signal corresponding to display data inputted from the data processing device,
wherein the timing generation circuit supplies, when setting information is set in the first register, a periodic timing signal to the interface circuit, and
wherein the interface circuit periodically updates, responding to the timing signal, a setting value stored in the second register with setting information inputted from the first non-volatile memory.

18. The display apparatus according to claim 17,
wherein the interface circuit includes:
a first interface circuit corresponding to a first external terminal; and
a second interface circuit corresponding to a second external terminal,
wherein the first interface circuit writes the command received from the data processing device via the first external terminal to the first register, and
wherein the second interface circuit writes setting information received from the first non-volatile memory via the second external terminal to the register group.

19. The display apparatus according to claim 18,
wherein the signal processing circuit includes;
a display data memory; and
a display output circuit which outputs display data stored in the display data memory as a gradation display signal, and
wherein the second register includes:
an adjustment register storing a setting signal for use in forming the gradation display signal; and
a screen composition register storing setting information corresponding to a display panel to which the gradation display signal is outputted.

20. The display apparatus according to claim 19, wherein the first interface circuit further includes a control unit which selectively deactivates, based on a command from the data processing device, a function for resetting the register group from an external terminal.

21. The semiconductor integrated circuit device according to claim 2, further comprising, internally, a second non-volatile memory, the second non-volatile memory storing part of the setting information,
wherein the part of the setting information is, when operation to write setting information to the group of registers is carried out, written to the group of registers along with other part of the setting information.

22. The semiconductor integrated circuit device according to claim 21, further comprising a control unit for selectively deactivating a function for resetting the group of registers from an external terminal.

23. The semiconductor integrated circuit device according to claim 21,
wherein the signal processing circuit includes:
a display data memory; and
a display output circuit which outputs display data stored in the display data memory as a gradation display signal, and
wherein the group of registers includes:
an adjustment register storing a setting signal for use in forming the gradation display signal; and
a screen composition register storing setting information corresponding to a display panel to which the gradation display signal is outputted.
